(19) United States
(12) Patent Application Publication
(10) Pub. No.: US 2008/0107266 A1
(43) Pub. Date: May 8, 2008

(54) CRYPTOLOGY CALCULATION FOR LAST USED AUTHENTICATION DEVICE

(75) Inventors: Patricia Kachouh, Sterling Heights, MI (US); Brian Marlett, Macomb, MI (US); Jose Luis Herrera Martinez, Jalisco (MX); Mauricio Carrera Manjarrez, Jalisco (MX)

Correspondence Address: SIEMENS CORPORATION;INTELLECTUAL PROPERTY LAW DEPARTMENT, 170 WOOD AVENUE SOUTH, attn: SV-CONTI TRANSITION, ISELIN, NJ, 08830, US

(73) Assignee: SIEMENS VDO AUTOMOTIVE CORPORATION, Auburn Hills, MI (US)

(21) Appl. No.: 11/930,876

(22) Filed: Oct. 31, 2007

Related U.S. Application Data
(60) Provisional application No. 60/856,689, filed on Nov. 3, 2006.

(51) Int. Cl. H04L 9/32

(52) U.S. Cl. 380/258

(57) ABSTRACT

A passive start and entry system includes a controller that determines the desired encryption for a last authenticated identification device during the period in which responses are received from any proximate identification devices. This process allows for the transmission of encrypted data to the last authenticated device without delay upon the expiration of the wait period.

### CROSS REFERENCE TO RELATED APPLICATION

The application claims priority to U.S. Provisional Application No. 60/856,689 which was filed on Nov. 3, 2006.

### BACKGROUND OF THE INVENTION

This invention generally relates to the authentication of passive entry and start devices. More particularly, this invention relates to the calculation of encrypted information utilized for authentication of remote identification devices.

Passive and active entry and start devices communicate with a module within a motor vehicle to authorize and perform desired functions remotely. Such functions include, for example, unlocking of the motor vehicle and enabling the starting system without a mechanical key. In order to prevent unauthorized access, the module and remote devices utilize an encryption to confirm the authenticity of the remote identification device. All encryptions require time for the calculations to be performed. Most systems include more than one authentication device, such as a key fob for example, that is authorized for operation of a single vehicle. Accordingly, a separate unique authentication is required for each of the different authentication devices. Determining which of the several authentication devices and than calculating a corresponding encryption increases overall system response times.

In one example, a passive authentication device begins communication upon some physical prompt, such as actuation of a vehicle door handle. Upon this action, the vehicle module sends out a low frequency radio signal and then waits for a reply from proximate authentication devices. Each authentication device then transmits after a desired elapsed time from the challenge transmission. The absence of a signal at a predefined time after the LF signal indicates that that particular authentication device is not in the area. Once, the time for reply for all of the authentication devices has past, the cryptology calculations for the authentication device present are performed. Such calculations can contribute to a perceptible wait period when instead an immediate response and actuation are desired.

Accordingly, it is desirable to design and develop an encryption calculation system and method that substantially reduces or eliminates any perceived hesitation in system response.

### SUMMARY OF THE INVENTION

An example passive entry and start system includes a controller that calculates the cryptology required for the last used remote identification device during idle transmission time or during the wait period where the controller is awaiting the response from proximate remote identification devices to reduce the overall system response time.

The system and method utilizes the last authentication time such that the controller will calculate the desired encryption for the last authenticated identification device. In this way, the controller does not wait to determine which of the plurality of identification devices is proximate, instead, it assumes that the last identification device will respond and determines the desired encryption prior to receipt of response signals from the proximate identification devices. Accordingly, this method and system shortens overall system response time.

These and other features of the present invention can be best understood from the following specification and drawings, the following of which is a brief description.

### BRIEF DESCRIPTION OF THE DRAWINGS

FIG. 1 is a schematic representation of the system according to the example system.

FIG. 2 is a schematic representation of the order of signal encryption calculation.

### DETAILED DESCRIPTION OF THE PREFERRED EMBODIMENT

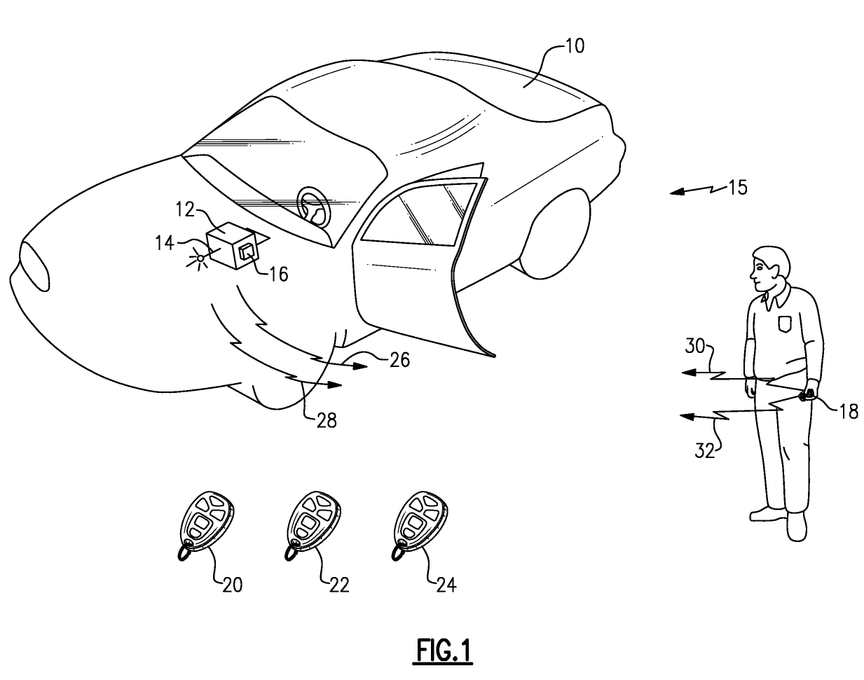

Referring to FIG. 1, a passive start and entry system 15 includes a controller 12 mounted within a vehicle 10. The controller 12 includes an antenna 14 and a memory device 16. The controller 12 will emit a challenge signal 26 that is designed to illicit a response from any proximate remote identification devices 18, 20, 22, 24. The example system 15 includes the remote identification devices 18, 20, 22, 24 that each will respond to the challenge signal 26 when within a proximate area of the vehicle 10.

Under the most common operating conditions, one of the several identification devices is used most often and therefore the calculation and wait for receipt of responses from multiple identification devices is not necessary. Further, during most operation sequences, only one of the plurality of identification devices 18, 20, 22, 24 will be in a location proximate to the vehicle and will send a response signal as is illustrated in the example. In the example illustrated in FIG. 1, the only proximate identification device 18 sends a response signal 30 in response to the challenge signal 26. The remainder of the plurality of identification devices are not in an area proximate to the vehicle 10 and therefore do not respond.

Upon receipt of the response signal 30 to the challenge signal 26 the controller 12 emits an encrypted signal 28 that is in turn responded to by the identification device 18. This second signal 32 by the identification device 18 includes the instructions and other data that are required to both prove validity of the identification device and also to provide instructions utilized by this system 15 to operate the various vehicle functions such as unlocking the door or allowing operation of the vehicle engine.

Calculation of the encrypted signal 28 by the controller 12 requires time. It is desirable to reduce the system response time such that no perceptible wait is experienced by a user. As appreciated, the determination and calculation of an encrypted signal may only take a few moments but any perceptible wait is undesirable. The example disclosed method and system includes the calculation of an encrypted signal using information relating to the identification device 18 from which the last signal was received.

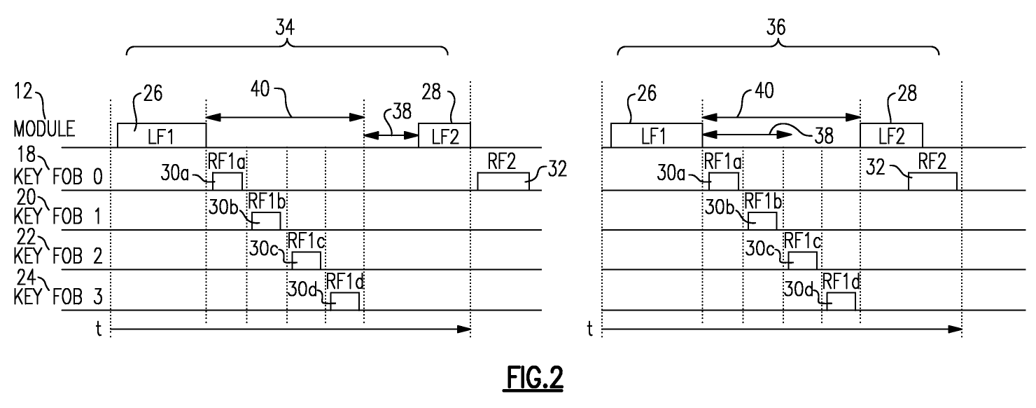

Referring to FIG. 2, a first sequence 34 illustrates the initial operation of the controller 12 where no prior identification device has been determined. In this process, the module 12 emits the challenge signal 26. A wait period follows the challenge signal 26. The wait period 40 includes sub-divided times 30A, 30B, 30C, 30D in which each of the identification devices 18,20,22,24 should respond if within an area to receive the challenge signals 26. After the wait period 40 has expired, the controller 12 will send a second signal 28. The second signal 28 is only sent after a calculation period 38. The calculation period 38 is the time required for the control module 12 to calculate the encryption that corresponds to the one identification device 18 that transmitted a response signal 30 to the initial challenge signal 26. In the example, the identification device 18 is the only one of the plurality of identification devices 18, 20, 22, 24 that responds. The controller 12 calculates an encryption that corresponds to the first identification device 18. The second signal 28 from the controller 28 is then sent to the identification device 18 and a response signal 32 is sent back to the controller 12 that includes a verification of the encryption and also instructions for operation of the vehicle 10.

A second cycle 36 that follows the first cycle 34 operates in a different manner that reduces the overall system response time. In the second cycle 36, because the identification device 18 had been authenticated by the controller 12 in the preceding first cycle 34, upon sending of the initial transmission 26, the controller 12 automatically determines the encryption required for transmission to the identification device 18 during the wait time 40. After the wait period 40 has expired the second transmission 28 is ready to be transmitted and includes the required encryption to verify the identification device 18. Upon expiration of the wait time 40 the transmission 28 is immediately transmitted to the identification device 18.

The example system reduces overall response time by calculating the encryption for the last utilized identification device prior to the wait period expiring such that upon the expiration of the wait period the desired second transmission from the controller can be transmitted without delay.

Accordingly, the system of this invention provides the means for reducing perceptible wait periods for authentication and operation of the system passive start and entry functions by calculating required encryptions for the last authenticated identification device during the wait period.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A passive start and entry system for a motor vehicle comprising:
a control module including a transmitter for transmitting a challenge transmission and a receiver for receiving a response to the challenge transmission; and
a plurality of remote control devices, wherein the control module calculates an encrypted signal for only a last authenticated one of the plurality of remote control devices before receipt of a response signal from any of the plurality of remote controls.

2. The system as recited in claim 1, wherein each of the plurality of remote control devices includes a unique identifier sent to the controller upon receipt of the challenge transmission

3. The system as recited in claim 2, wherein each of the plurality of remote control devices proximate the control module sends a response transmission in response to the challenge transmission.

4. The system as recited in claim 1, wherein the control module waits a desired period for responses from any of the plurality of remote control devices prior to sending the encrypted signal.

5. The system as recited in claim 4, wherein the control module sends the encrypted signal to the last authenticated one of the plurality of remote control devices after the desired wait time has expired.

6. The system as recited in claim 5, wherein the control module calculates the encrypted signal during the desired period for responses from any of the plurality of remote control devices.

7. The system as recited in claim 1, wherein the control module calculates a new encrypted signal after the wait time in response to receiving a response from a one of the plurality of remote control devices not authenticated in the immediately preceding authentication process.

8. A method of authenticating a remote control device for a passive start and entry system comprising the steps of:
a) sending a challenge transmission from a control module;
b) calculating an initial encrypted signal for a last authenticated one of a plurality of remote control devices with the control module during a wait time for a response from any of the plurality of remote control devices to the challenge transmission; and
c) sending the initial encrypted signal to the last authenticated one of the plurality of remote control devices upon expiration of the wait time

9. The method as recited in claim 8, including the step of receiving a command prompt in response to the encrypted signal from the last authenticated one of the plurality of remote control devices.

10. The method as recited in claim 9, wherein the initial encrypted signal is calculated in parallel with the time for a response by any of the plurality of remote control devices.

11. The method as recited in claim 8, wherein the encrypted signal calculated in parallel corresponds only for use with the last authenticated one of the plurality of remote control devices.

12. The method as recited in claim 8, including the step of calculating a new encrypted signal after the wait period in response to receipt of a response signal from one of the plurality of remote control devices that is not the last authenticated one of the plurality of remote control devices.

13. The method as recited in claim 8, wherein the challenge transmission comprises a low frequency signal.

14. The method as recited in claim 8, wherein the response to the encrypted signal includes an encrypted radio frequency signal from the last authenticated one of the plurality of remote control devices.

15. The method as recited in claim 8 wherein the challenge transmission comprises 32 bits of information.
